(19) United States
(12) Patent Application Publication
(10) Pub. No.: US 2011/0319561 A1
(43) Pub. Date: Dec. 29, 2011

(54) ACRYLIC ACID SWELLABLE ALKALI ACRYLIC EMULSIONS, THEIR USE IN AQUEOUS FORMULATIONS AND THE FORMULATIONS CONTAINING THEM

(75) Inventor: Jean-Marc SUAU, Lucenay (FR)

(73) Assignee: COATEX S.A.S., Genay (FR)

(21) Appl. No.: 13/150,447

(22) Filed: Jun. 1, 2011

Related U.S. Application Data
(60) Provisional application No. 61/360,580, filed on Jul. 1, 2010.

(30) Foreign Application Priority Data
Jun. 25, 2010 (FR) 10 55077

(51) Int. Cl. C08L 33/24; B82Y 30/00

(52) U.S. Cl. 524/817; 977/773

(57) ABSTRACT

New methacrylic acid-free direct emulsions of a polymer in water. Methods of making and using.

### REFERENCE TO PRIOR APPLICATIONS

This application claims priority to U.S. provisional application Ser. No. 61/360,580, filed Jul. 1, 2010; and to French patent application 10 55077, filed Jun. 25, 2010, both incorporated herein by reference.

### FIELD OF THE INVENTION

The present invention relates to new methacrylic acid-free alkali swellable thickener emulsions, this monomer previously being indispensable in this type of emulsion, which made manufacturers dependent on this raw material. These new emulsions can contain a certain quantity of 2-acrylamido-2-methylpropane sulfonic acid (or AMPS, CAS No: 40623-75-4). They may also be made in the absence of a surfactant, which prevents the formation of foam. Finally, they are preferably effective for thickening aqueous media, including media with a pH between 5 and 6, such as the skin.

Additional advantages and other features of the present invention will be set forth in part in the description that follows and in part will become apparent to those having ordinary skill in the art upon examination of the following or may be learned from the practice of the present invention. The advantages of the present invention may be realized and obtained as particularly pointed out in the appended claims. As will be realized, the present invention is capable of other and different embodiments, and its several details are capable of modifications in various obvious respects, all without departing from the present invention. In this regard, the description herein is to be understood as illustrative in nature, and not as restrictive.

### BACKGROUND OF THE INVENTION

Aqueous formulations are found that may contain mineral fillers in very many domains: those of aqueous paints, paper coating dispersions, mineral suspensions, detergents, cosmetic formulations, or of concretes and cements.

Controlling their rheology is a necessity, both at the manufacturing stage as well as during their transport, storage or in the course of their implementation. The diversity of practical constraints at the level of each of these steps reflects a multiplicity of rheological behaviours. In the case of a paint, for example, the need of the person skilled in the art can be summarized as that of obtaining a thickening effect, both for reasons of stability over time as well as for a possible application of the paint to a vertical surface, the absence of splashing when using it, or sagging after its use, etc.

Indeed, products that contribute to this control of rheological behaviour have been designated as thickeners. Among these thickeners, the person skilled in the art has long known the particular category of alkali swellable acrylic emulsions which are polymers that are emulsified in water using surfactants, the polymers consisting of at least one non water-soluble monomer and at least one neutralisable alkali water-soluble monomer, including methacrylic acid.

As used herein, the expression “direct emulsion of a polymer in water” refers to a stable and homogeneous dispersion of polymer particles in water (it does not refer here to oil in water or water in oil type emulsions which involve the existence of two distinct phases, one aqueous and the other oily). As to the expression “swellable alkali polymer”, it means that the polymer is capable, when the medium is alkaline, of incorporating a quantity of water such that there is the formation of a gel.

There are 2 major families of alkali swellable acrylic thickeners: thickeners of the ASE (Alkali Swellable Emulsion) type and those of HASE (Hydrophobically modified Alkali Swellable Emulsion) type. The first designate copolymers of methacrylic acid with a non-water soluble ester of this acid, and the second designate methacrylic acid based copolymers of a non-water soluble ester of the (meth)acrylic acid and a monomer with so-called “associative” hydrophobic groups. In addition, these copolymers can be cross-linked.

The mechanisms of action of these products differ. Polymers of the ASE type only thicken in the neutralized state, hence the expression “alkali swellable”: an ionic repulsion mechanism is then induced between the various carboxylate groups on the polymer chain. These ionized groups polarize the water molecules which causes the increase in the viscosity of the medium. In addition to the above-mentioned ionic phenomenon, polymers of the HASE type bring into play interactions between their associative hydrophobic groups which also contributes to thickening the medium. These mechanisms, in particular the alkali swellable nature of these emulsions and their ability to thicken an aqueous medium at a pH close to neutrality, have been described in documents WO 2007/144721 and “Practical guide to associative thickeners” (Proceedings of the Annual Meeting Technical Program of the FSCT, 2000, 78th, 644-702).

There are many applications that can be found for these thickeners in paint, coating dispersions or cosmetics (see patent applications FR 2 693 203 A1, FR 2 872 815 A1, FR 2 633 930 A1, FR 2 872 815 A1). In addition, they exist in the commercial form, particularly through the range of products Rheocarb™, Rheocoat™, Thixol™, Rheotech™, Polyphobe™ and Viscoatex™ marketed by the company COATEX S.A.S.

Returning to the constitution of ASE and HASE type emulsions, methacrylic acid appears today as an unavoidable monomer which constitutes at least 20% by weight of these thickener polymers. Due to its carboxylic acid function, it participates in the increase in viscosity of the medium through an already described ionic phenomenon, and it is easily polymerizable in an aqueous emulsion in the presence of surfactants with hydrophobic monomers, including the associative monomers.

These polymerizations in emulsion are widely illustrated in the scientific literature. Reference can be made to the publications “Synthesis of an alkali-swellable emulsion and its effect on the rate of polymer diffusion in poly (vinyl acetate-butyl acrylate) latex films” (Journal of Polymer Science, Part A: Polymer Chemistry, 2005, 43 (22), pp. 5632-5642), “Structural and rheological properties of hydrophobically modified alkali-soluble emulsion solutions” (Journal of Polymer Science, Part B: Polymer Physics, 2002, 40 (18), pp. 1985-1994) “Viscoelastic properties of hydrophobically modified alkali-soluble emulsion in salt solutions” (Polymer, 1999, 40 (23), pp. 6369-6379), “Dissolution behaviour in water of a model hydrophobic alkali-swellable emulsion polymer with C20H41 groups” (Canadian Journal of Chemistry (1998), 76(11), pp. 1779-1787), and to patent applications EP 0 089 213 A1, EP 0 646 606 A1, EP 0 979 833 A1, for the ASEs, and EP 0 013 836 A1, WO 93/2454 A1, U.S. Pat. No. 4,268,641 A1, U.S. Pat. No. 4,421,902 A1, U.S. Pat. No. 3,915,921 A1 for the HASEs.

Today, methacrylic acid is considered an indispensable monomer in ASE and HASE type emulsions: this data is to a large extent integrated into the industrial world, and is not questioned by the person skilled in the art. But it is precisely the mandatory nature of methacrylic acid that is a problem. We live in an era when the shortage of raw materials and their cost fluctuation indexed to that of a barrel of crude oil are recurring data in the chemical industry. Therefore, a technology attached exclusively to a material becomes strategically risky for its manufacturers and users.

### DETAILED DESCRIPTION OF THE PREFERRED EMBODIMENTS

It is to address this major drawback that the inventor herein has undertaken research with the aim of substituting acrylic acid for methacrylic acid in ASE and HASE type emulsions. However, no document on the state of the art discloses a technique for the direct polymerization of acrylic acid in an emulsion without methacrylic acid and in the presence of a hydrophobic monomer, the acrylic acid in such a case representing at least 20% by weight of the monomers to be polymerized.

As described in more detail below, the present inventor was able to demonstrate that such a direct polymerization in emulsion was possible, to the extent that use was made of a certain quantity of a particular monomer which is 2-acrylamido-2-methylpropane sulfonic acid (or AMPS, CAS No: 40623-75-4). In a completely surprising and beneficial way, true emulsions of the ASE and HASE type, free of methacrylic acid, were thus manufactured.

Now the acrylic acid based thickeners known to the person skilled in the art are cross-linked acrylic acid polymers obtained by precipitation in a solvent (see document EP 0 584 771 A1), or polymers that are cross-linked or hydrophobically modified in reverse water-in-oil emulsions (see documents FR 2 873 126 A1 and FR 2 782 086 A1), or finally, high molecular weight polymers (greater than 10,000,000 g/mol) obtained in solution in water and dried (known by the name of superabsorbent polymers or SAPs; see in particular documents EP 0 371 421 A1 and U.S. Pat. No. 5,221,722 A1). Nothing exists in the state of the art for the production of alkali swellable emulsions containing at least 20% by weight of acrylic acid, and free of methacrylic acid.

In addition, the process which is an object of the present invention has a preferential variant that produces other benefits: it can be implemented without a surfactant or solvent other than water. Now, it is well known that these latter generate many problems in the implementation of emulsions of the ASE and HASE type in an aqueous formulation.

In the case of a paint, there may be the creation of inhomogeneities, and even an alteration in the properties of the final product, that is, of the dry film of paint resulting from the drying of the aqueous formulation. The formation of “craters” or insoluble particles that are heterogeneities that harm the aesthetic appearance and properties of the film surface can also be observed (the mechanical aspect, but also the optical properties and the condition of the surface). Finally, it is well known that the presence of surfactants in a paint formulation will ultimately degrade the washable property of the dry film (see “Effect of surfactants used for binder synthesis on the properties of latex paints”, Progress in Organic Coatings, 2005, 53 (2), pp. 112-118).

Other advantages of the inventor's new methacrylic acid-free ASE and HASE type emulsions reside in the fact that they have a commercial dry extract (greater than 25% by dry weight of active ingredient), are stable over time and are characterized by particle sizes similar to the emulsion of the prior art. Finally, their thickening effectiveness is demonstrated.

Another object of the present invention lies in the use of the aforementioned emulsions as thickening agents in aqueous formulations.

In more detail, a first object of the present invention is a manufacturing process, wherein said process involves the polymerization reaction of, expressed in % by weight of each of the monomers:
a) 20% to 80% by weight of acrylic acid,
b) 10% to 90% by weight of at least one ester of (meth)acrylic acid,
c) 0.05% to 22% by weight of 2-acrylamido-2-methylpropane sulfonic acid,
d) 0 to 1% by weight of at least one crosslinking monomer,
the total a)+b)+c)+d) being equal to 100%.

Another object of the present invention is a manufacturing process, wherein said process involves the polymerization reaction of, expressed in % by weight of each of the monomers:
a) 20% to 80% by weight of acrylic acid,
b) 10% to 90% by weight of at least one ester of (meth)acrylic acid,
c) 10% to 25% by weight of a monomer containing a hydrophobic group,
d) 0.05% to 22% by weight of 2-acrylamido-2-methylpropane sulfonic acid,
e) 0 to 1% by weight of at least one crosslinking monomer,
the total a)+b)+c)+d) being equal to 100%,

Other characteristics of this process (temperature, choice of catalytic system, use of a transfer agent, employment of a possible crosslinking agent, etc.) are within the choice and skill of the person having ordinary skill in this art.

In a preferred embodiment the ester of (meth)acrylic acid is chosen from ethyl acrylate, butyl acrylate, methyl methacrylate, and their mixtures.

In a preferred embodiment the monomer containing a hydrophobic group has the general formula:

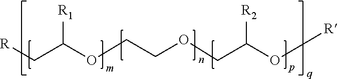

where:
m, n, p and q are integers and m, n, p are less than 150, q is greater than 0 and at least one integer from among m, n and p is non-zero.
R contains a polymerizable vinyl function,
R₁ and R₂ are identical or different and represent hydrogen atoms or alkyl groups,
R′ is a hydrophobic group with at least 6 and not more than 36 carbon atoms.

In a preferred embodiment the crosslinking monomer is chosen from among ethylene glycol dimethacrylate, trimethylolpropane triacrylate, diallyl phthalate, allyl acrylate, the allyl maleates, methylene-bis-acrylamide, methylene-bis-methacrylamide, tetrallyloxyethane, the triallyl cyanurates, the allylic ethers obtained from polyols.

In a preferred embodiment the aqueous emulsion presents a dry extract that is between 10% and 50% by dry weight of polymer with respect to its total weight.

In a preferred embodiment the emulsion has a particle size between 50 nm and 500 nm.

In a preferred embodiment the polymer presents a mean molar mass by weight of between 20,000 g/mol and 1,000,000 g/mol.

In a preferred variant, the process does not use surfactants or solvents other than water.

Another object of the present invention is the use in a manufacturing process of an emulsion of the ASE or HASE type, of 2-acrylamido-2-methylpropane sulfonic acid as an agent enabling the complete substituting of methacrylic acid by acrylic acid.

Another object of the present invention is a direct aqueous emulsion of a polymer of, expressed in % by weight of each monomer:
a) 20% to 80% by weight of acrylic acid,
b) 10% to 90% by weight of at least one ester of (meth)acrylic acid,
c) 0.05% to 22% by weight of 2-acrylamido-2-methylpropane sulfonic acid,
d) 0 to 1% by weight of at least one crosslinking monomer,
the total a)+b)+c)+d) being equal to 100%.

Another object of the present invention is a direct aqueous emulsion of a polymer of, expressed in % by weight of each monomer:
a) 20% to 80% by weight of acrylic acid,
b) 10% to 90% by weight of at least one ester of (meth)acrylic acid,
c) 10% to 25% by weight of a monomer containing a hydrophobic group,
d) 0.05% to 22% by weight of 2-acrylamido-2-methylpropane sulfonic acid,
e) 0 to 1% by weight of at least one crosslinking monomer,
the total a)+b)+c)+d) being equal to 100%.

In a preferred variant the monomer containing a hydrophobic group has the general formula:

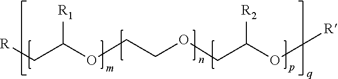

where:
m, n, p and q are integers and m, n, p are less than 150, q is greater than 0 and at least one integer from among m, n and p is non-zero.
R contains a polymerizable vinyl function,
R1 and R₂ are identical or different and represent hydrogen atoms or alkyl groups,
R′ is a hydrophobic group with at least 6 and not more than 36 carbon atoms.

In a preferred variant the crosslinking monomer is chosen from among ethylene glycol dimethacrylate, trimethylolpropane triacrylate, diallyl phthalate, allyl acrylate, the allyl maleates, methylene-bis-acrylamide, methylene-bis-methacrylamide, tetrallyloxyethane, the triallyl cyanurates, the allylic ethers obtained from polyols.

In a preferred variant the emulsion presents a dry extract of between 10% and 50% by dry weight of polymer in relation to its total weight.

In a preferred variant the emulsion has a particle size between 50 nm and 500 nm.

In a preferred variant the polymer presents a mean molar mass by weight of between 20,000 g/mol and 1,000,000 g/mol.

In a preferred variant, this emulsion is free of surfactants and solvents other than water.

Another object of the present invention lies in the use of the above-mentioned emulsion as a thickening agent for an aqueous formulation. In one embodiment, the emulsion is introduced into the medium to be thickened, the pH of which is maintained close to neutral, in order to obtain the thickening effect. The person skilled in the art, using routine experiments, will be able to find the pH starting from which the phenomenon of thickening is observed.

Preferred embodiments include wherein the formulation is selected from an aqueous paint, a paper coating dispersion, an aqueous suspension of mineral substances, a detergent, a cosmetic formulation, and, more specifically, a cosmetic formulation to be applied to the skin or a region of the body where the pH is between 5 and 6.

Another object of the present invention resides in an aqueous formulation containing the above mentioned emulsion, the formulation being selected from an aqueous paint, a paper coating dispersion, an aqueous suspension of mineral substances, a detergent, a cosmetic formulation, or containing a hydraulic binder, a cosmetic formulation, particularly one to be applied to the skin or a region of the body where the pH is between 5 and 6, etc.

### EXAMPLES

### Example 1

### Test No. 1 According to the Invention

This test concerns the manufacture of an ASE type emulsion containing a copolymer consisting of, expressed in % by weight of each of its monomers:
a) 36.4% acrylic acid,
b) 62.4% ethyl acrylate,
c) 1.2% AMPS

Into a 1 litre reactor equipped with mechanical agitation and an oil bath type heating system, introduce 550 g of bipermuted water and 7.0 g of an AMPS solution (55% solution of AMPS in water neutralized with sodium hydroxide, marketed by the LUBRIZOL™ company under the name AMPS 2405).

The medium is heated to 78° C. and then the catalytic system, consisting of 0.96 g of ammonium persulfate dissolved in 10 g of bipermuted water and 0.096 g of sodium metabisulphite dissolved in 10 g of bipermuted water is introduced using a funnel.

Next, 236 g of ethyl acrylate and 85 g of acrylic acid (90%) is introduced in a continuous and progressive manner. For the entire duration of the addition, the temperature of the reaction medium is maintained at 78° C. (±2).

Once the addition is completed, the pump is rinsed with 20 g of bipermuted water and the reaction is allowed to continue for 30 minutes at 78° C. (±2).

Then 0.10 g of ammonium persulfate dissolved in 25 g of water is added in 30 minutes while maintaining the temperature at 80° C. (±2) and the reaction is allowed to continue for 1 hour at 87° C. (±2).

An emulsion is thus obtained that contains 32.4% by dry weight of active ingredient, and whose particle size, measured by Dynamic Light Scattering is equal to 99 nm.

### Comparative Tests

First, an attempt was made to produce the same polymer as in test 1, but without using AMPS, that is, a polymer consisting of 36.5 percent by weight of acrylic acid and 63.5% by weight of ethyl acrylate.

To do this, the same protocol as above was used, except for the initial introduction of AMPS. After letting the reaction proceed at 87° C. for 1 hour, the formation of a cloudy precipitate in solution was observed, a part of which settled at the level of the axis of the reactor (riprap). The size of the particles formed exceeded 500 nm. The medium, very inhomogeneous and rich in large particles, does not lend itself to handling, and particularly to pumping operations. In addition, storage risks increasing the sedimentation of the product.

A quantity of AMPS greater than 22% by weight of the total mass of the monomers employed was then used according to an operating procedure identical to that described in test No. 1, the copolymer then being constituted, expressed in % by weight of each of its monomers of:
a) 36.5% acrylic acid,
b) 38.5% ethyl acrylate,
c) 25.0% AMPS.

The formation of insoluble species which precipitated in the medium was then observed.

Next, the AMPS (1.2%, weight/weight) was then replaced by another monomer used in ASE and HASE emulsions: ethyl acrylate. The creation of homogeneous emulsions was not realised; the observations are the same as the previous ones, with the formation of a precipitate, the riprap phenomenon and the harmful consequences which result from it.

The AMPS was then substituted (always 1.2% weight/weight) by styrene, lauryl methacrylate, 2-sulfoethyl methacrylate, sodium styrene sulfonate, the sodium salt of 1-allyloxy-2-hydroxypropyl sulfonate (Sipomer COPS 1) for the identical results (presence of insolubles and the riprap phenomenon).

### Tests No. 2 through 11 According to the Invention

Tests No. 2 through 11 concern the synthesis of other emulsions illustrating the invention according to the same operating procedure as described above.

Tests Nos. 2-8 illustrate other monomer compositions with an AMPS mass level fixed at 1.2%, while tests Nos. 9-11 illustrate other AMPS levels (a constant mass ratio between ethyl acrylate and acrylic acid was maintained).

The characteristics of the emulsions obtained are given in table 1.

TABLE 1

| | Monomer | | Particle |
|---|---|---|---|
| Test | composition | ES | diameter |
| No. | (% mass) | (%) | (nm) |
| 1 | 1.2 AMPS/62.4 EA/36.4 AA | 29.6 | 153 |
| 2 | 1.2 AMPS/68.7 EA/30.1 AA | 32.8 | 115 |
| 3 | 1.2 AMPS/74.6 EA/24.2 AA | 32.4 | 99 |
| 4 | 1.2 AMPS/80.4 EA/18.4 AA | 32.2 | 102 |
| 5 | 1.2 AMPS/28.35 BuA/70.45 AA | 37.6 | 287 |
| 6 | 1.2 AMPS/74.1 EA/18.4 AA/6.3 MEM | 33.2 | 96 |
| 7 | 1.2 AMPS/67.8 EA/18.4 AA/12.6 MEM | 32.4 | 106 |
| 8 | 1.2 AMPS/53.25 EA/35.8 AA/ | 33.1 | 185 |
| | 9.75 MethC22OE25 | | |
| 9 | 10 AMPS/57.9 EA/32.1 AA | 29.6 | 175 |
| 10 | 15 AMPS/55.4 EA/29.6 AA | 29.6 | 215 |
| 11 | 20 AMPS/52.9 EA/27.1 AA | 29.6 | 276 |

In this table, MethC220E25 designates a monomer of formula (I) in which R designates the methacrylate function, m=p=0, n=25, and R′ refers to a methyl group, EA designates ethyl acrylate, BuA butyl acrylate, MEM methyl methacrylate, AA and MA acrylic and methacrylic acid. ES is dry weight of active ingredient.

### Example 2

This example demonstrates the thickening power of emulsions according to the invention implemented in water so as to have an active ingredient content of 5% in dry polymer. After introduction in water, the medium is neutralized by the addition of sodium hydroxide at a pH between 4.9 and 5.5, and the Brookfield™ viscosity of the medium is measured at 25° C. and 100 RPM, the values of which are reported in table 2

TABLE 2

| Emulsion | Brookfield ™ |
|---|---|
| according to | viscosity (mPa · s) |
| Test No. | of the gel at 5% |
| 1 | 3320 |
| 9 | 2830 |
| 10 | 1750 |
| 11 | 1310 |

The thickening character of the emulsions manufactured is thus demonstrated from the moment they are placed under alkaline conditions.

Moreover, it is surprising to note that the thickening effect occurs at such a low pH; usually, emulsions of the ASE and HASE type thicken in a pH ranging from 6 to 7.

This “low pH” thickening is particularly difficult to obtain, and is quite interesting in the cosmetics domain, where a thickening effect is sought at a pH in the range of the skin, i.e. in a range between 5 and 6 pH units. This is reported in document EP 2 027 169 A1.

### Example 3

This example illustrates the implementation in the formulation of a concrete, of thickening emulsions of the commercial ASE type (containing surfactants) and of an emulsion according to the invention that is free of surfactants.

To do so, a concrete is prepared according to the techniques that are well described in the literature, consisting of:
300 kg of CEM 152.5 N cement;
880 of large 10/20 stones;
110 kg of 0/4 sand;
   where the water to cement ratio W/C is set at 0.5, and into which is introduced, in relation to the dry weight of the cement:
1.23% by weight in the capacity of a dispersant marketed by the COATEX™ company under the name Ethacryl™ 1030;
1% by weight in the capacity of a defoamer marketed by the HUNTSMANN™ company under the name Empilan PF 7169.
   Tests A, B, C and D respectively implement in the formulation of concrete 0.7% by weight in the capacity:
of an ASE type emulsion containing surfactants and marketed by the COATEX™ company under the name Viscoatex™ 730;
of an ASE type emulsion containing surfactants and marketed by the COATEX™ company under the name Rheocoat™ 35;
of a HASE type emulsion containing surfactants and marketed by the COATEX™ company under the name Rheocoat™ 66;
of an emulsion according to the invention, which is described in test No. 1.

For each of the tests A, B, C and D, the occluded air was measured according to standard EN 12350-7. The results obtained were 9.5%, 12.0%, 12.5% and 3.0% respectively.

The thickening emulsion according to the invention thus considerably reduces the amount of air introduced into the formulation. In the end, there is thus a more compact product with improved resistance.

As noted above, as used herein, the expression “direct emulsion of a polymer in water” refers to a stable and homogeneous dispersion of polymer particles in water (it does not refer here to oil in water or water in oil type emulsions which involve the existence of two distinct phases, one aqueous and the other oily). As to the expression “swellable alkali polymer”, it means that the polymer is capable, when the medium is alkaline, of incorporating a quantity of water such that there is the formation of a gel.

The above written description of the invention provides a manner and process of making and using it such that any person skilled in this art is enabled to make and use the same, this enablement being provided in particular for the subject matter of the appended claims, which make up a part of the original description.

As used herein, the words “a” and “an” and the like carry the meaning of “one or more.”

The phrases “selected from the group consisting of,” “chosen from,” and the like include mixtures of the specified materials. Terms such as “contain(s)” and the like are open terms meaning ‘including at least’ unless otherwise specifically noted.

All references, patents, applications, tests, standards, documents, publications, brochures, texts, articles, etc. mentioned herein are incorporated herein by reference. Where a numerical limit or range is stated, the endpoints are included. Also, all values and subranges within a numerical limit or range are specifically included as if explicitly written out.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. In this regard, certain embodiments within the invention may not show every benefit of the invention, considered broadly.

1. A process for producing a direct emulsion of a polymer in water, wherein said process comprises the polymerization reaction of one of the following monomer groups A and B, expressed in % by weight of each monomer, in water, to produce said polymer:
monomer group A:
a) 20% to 80% by weight of acrylic acid,
b) 10% to 90% by weight of at least one ester of (meth)acrylic acid,
c) 0.05% to 22% by weight of 2-acrylamido-2-methylpropane sulfonic acid,
d) 0 to 1% by weight of at least one crosslinking monomer,
monomer group B:
a) 20% to 80% by weight of acrylic acid,
b) 10% to 90% by weight of at least one ester of (meth)acrylic acid,
c) 10% to 25% by weight of a monomer comprising a hydrophobic group,
d) 0.05% to 22% by weight of 2-acrylamido-2-methylpropane sulfonic acid,
e) 0 to 1% by weight of at least one crosslinking monomer,
wherein the total of a)+b)+c)+d) in monomer group A and the total of a)+b)+c)+d)+e) in monomer group B is 100%, and wherein said polymer is methacrylic acid-free.

2. The process according to claim 1, wherein the ester of (meth)acrylic acid is selected from the group consisting of ethyl acrylate, butyl acrylate, methyl methacrylate, and mixtures thereof.

3. The process according to claim 1, wherein the polymer is a polymer comprising, in polymerized form, monomers of monomer group B, and wherein the monomer comprising a hydrophobic group has the general formula: 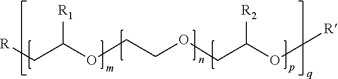
where:
m, n, p and q are integers and m, n, p are less than 150, q is greater than 0 and at least one integer from among m, n and p is non-zero.
R contains a polymerizable vinyl function,
R1 and R₂ are identical or different and represent hydrogen atoms or alkyl groups,
R′ is a hydrophobic group with at least 6 and not more than 36 carbon atoms.

4. The process according to claim 1, wherein the crosslinking monomer is selected from the group consisting of ethylene glycol dimethacrylate, trimethylolpropane triacrylate, diallyl phthalate, allyl acrylate, allyl maleates, methylene-bis-acrylamide, methylene-bis-methacrylamide, tetrallyloxyethane, triallyl cyanurates, allylic ethers obtained from polyols, and mixtures thereof.

5. The process according to claim 1, wherein the emulsion produced comprises 10%-50% by weight of polymer with respect to its total weight.

6. The process according to claim 1, wherein the emulsion produced has a particle size of 50 nm-500 nm.

7. The process according to claim 1, wherein the polymer produced has a mean molar mass by weight of 20,000 g/mol-1,000,000 g/mol.

8. The process according to claim 1, wherein it does not use a surfactant or a solvent other than water.

9. The process according to claim 1, comprising the polymerization reaction of monomer group A.

10. The process according to claim 1, comprising the polymerization reaction of monomer group B.

11. In a process for the manufacture of an ASE or HASE emulsion using methacrylic acid, the improvement therein being the use of 2-acrylamido-2-methylpropane sulfonic acid and the complete substitution of methacrylic acid by acrylic acid.

12. A direct emulsion of a polymer in water produced by the process of claim 1.

13. A direct emulsion of a polymer in water, wherein the polymer is a polymer comprising, in polymerized form, monomers of one of the following monomer groups A and B, expressed in % by weight of each monomer:
monomer group A:
e) 20% to 80% by weight of acrylic acid,
f) 10% to 90% by weight of at least one ester of (meth)acrylic acid,
g) 0.05% to 22% by weight of 2-acrylamido-2-methylpropane sulfonic acid,
h) 0 to 1% by weight of at least one crosslinking monomer,
monomer group B:
f) 20% to 80% by weight of acrylic acid,
g) 10% to 90% by weight of at least one ester of (meth)acrylic acid,
h) 10% to 25% by weight of a monomer comprising a hydrophobic group,
i) 0.05% to 22% by weight of 2-acrylamido-2-methylpropane sulfonic acid,
j) 0 to 1% by weight of at least one crosslinking monomer,
wherein the total of a)+b)+c)+d) in monomer group A and the total of a)+b)+c)+d)+e) in monomer group B is 100%, and wherein said polymer is methacrylic acid-free.

14. The direct emulsion of a polymer in water as claimed in claim 13, wherein the polymer is a polymer comprising, in polymerized form, monomers of monomer group B, and wherein the monomer comprising a hydrophobic group has the general formula: 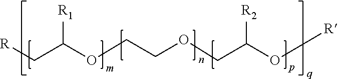
where:
m, n, p and q are integers and m, n, p are less than 150, q is greater than 0 and at least one integer from among m, n and p is non-zero.
R contains a polymerizable vinyl function,
R1 and R₂ are identical or different and represent hydrogen atoms or alkyl groups,
R′ is a hydrophobic group with at least 6 and not more than 36 carbon atoms.

15. The direct emulsion of a polymer in water as claimed in claim 13, wherein the crosslinking monomer is selected from the group consisting of ethylene glycol dimethacrylate, trimethylolpropane triacrylate, diallyl phthalate, allyl acrylate, allyl maleates, methylene-bis-acrylamide, methylene-bis-methacrylamide, tetrallyloxyethane, triallyl cyanurates, allylic ethers obtained from polyols, and mixtures thereof.

16. The direct emulsion of a polymer in water as claimed in claim 13, wherein the emulsion comprises 10%-50% by weight of said polymer with respect to its total weight.

17. The direct emulsion of a polymer in water as claimed in claim 13, wherein polymer particles therein have a particle size of 50 nm-500 nm.

18. The direct emulsion of a polymer in water as claimed in claim 13, wherein the polymer has a mean molar mass by weight of 20,000 g/mol-1,000,000 g/mol.

19. The direct emulsion of a polymer in water as claimed in claim 13, wherein said emulsion is free of surfactants and solvents other than water.

20. A method of thickening an aqueous formulation, comprising adding to said aqueous formulation the direct emulsion of a polymer in water as claimed in claim 13.
